(19) United States
(12) Patent Application Publication
(10) Pub. No.: US 2012/0131107 A1
(43) Pub. Date: May 24, 2012

(54) Email Filtering Using Relationship and Reputation Data

(75) Inventor: David N. Yost, Bellevue, WA (US)

(73) Assignee: Microsoft Corporation, Redmond, WA (US)

(21) Appl. No.: 12/949,713

(22) Filed: Nov. 18, 2010

(51) Int. Cl. G06F 15/16

(52) U.S. Cl. 709/206

(57) ABSTRACT

The subject disclosure is directed towards reducing the amount of resources needed to scan email messages for spam. In general, the previous email relationship between a sender and recipient, if any, may be considered in determining how aggressive the filtering level is set for scanning a message for spam, e.g., which filters will be used in the scan. For existing relationships where there has been no previously detected spam (there is good reputation data associated with the relationship), a less aggressive filtering level may be used, thereby saving resources. A relationship may be directly between the sender and recipient, or may be indirect, e.g., via a common third party. Also described is differentiating email from bulk senders from other email messages, for different handling, including spam filtering.

### BACKGROUND

E-mail spam refers to unsolicited email messages that are sent by “spammers” to large numbers of recipients, few of whom want to receive them. Spamming is undesirable in many ways, including that it costs recipients time to delete the messages, and requires email service providers to provide resources to distribute and/or store the generally unwanted messages. Moreover, sometimes spam is malicious, containing files that if activated can damage the computer system and/or steal sensitive information.

Many different types of filtering algorithms are run against an email message to determine whether that message is spam, so as to block spam messages or move them to a junk folder. However, processing with these algorithms is expensive due to the large amount of CPU time required to scan the messages. Also, the more algorithms that are run, the greater the chance of mislabeling an email message as being spam when it is not. Any technology that reduces the expense that results from processing email messages for spam, and/or reduces the number of mislabeled messages, is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which emails are scanned with selected filters (e.g., algorithms) corresponding to a selected filtering level, which may be chosen based upon any previous email relationships between senders and recipients, and associated reputation data (e.g., whether a previous email communication was detected as spam). In one implementation, when an email message directed from a sender to a recipient is received at a filtering mechanism, the IP address and domain of the sender are validated as to whether this IP address normally sends from the domain identified in the message. If not, an aggressive filtering level is chosen for scanning the message, e.g., all available filters.

If the IP address and domain of the sender validate, the filtering mechanism determines whether the sender and recipient have a previous good (non-spam) email relationship, e.g., by accessing a data store containing relationship and reputation information. If so, a less aggressive filtering level may be chosen for scanning the message, such as to scan with only filters that detect malware, for example.

In one aspect, if a direct relationship between the sender and recipient does not exist (e.g., there are zero or less than a threshold number of communications), the filtering mechanism may look for an indirect relationship. In one implementation, this corresponds to the sender and recipient each having an email relationship with a common third party. If such an indirect relationship exists, the filtering level may be chosen based upon the indirect relationship, and any associated reputation data.

In one aspect, email messages from bulk senders are differentiated from other email messages. Such bulk sender messages may be categorized (e.g., as a retail message, a newsletter and so on), and may be blocked or filtered based upon their bulk sender status and/or category.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example filtering system including a filtering mechanism that scans incoming email messages for spam, including by accessing relationship data indicative of previous email communications between senders and recipients to determine a filtering level.

FIG. 2 is a flow diagram representing an example steps for determining a filtering level based upon information in an email message and any relationship and reputation data associated with the sender and recipient of that message.

FIG. 3 is a flow diagram representing example steps for handling an email message received from a bulk sender.

FIG. 4 is a block diagram representing exemplary non-limiting networked environments in which various embodiments described herein can be implemented.

FIG. 5 is a block diagram representing an exemplary non-limiting computing system or operating environment in which one or more aspects of various embodiments described herein can be implemented.

### DETAILED DESCRIPTION

Various aspects of the technology described herein are generally directed towards enhancing the classification of which emails are spam and which are not, by using social relationships of users (when possible) to determine how aggressive spam filtering will be, and thus how much CPU time is used, in scanning the email message. In addition to taking overall less CPU time, the technology also reduces the number of emails which are mislabeled as spam by not applying more aggressive filtering on emails deemed via the relationship data as likely to be good (that is, not spam).

In one aspect, the technology makes use of the history that users have of sending email back and forth to each other, and uses that information to determine how aggressively email messages are scanned for spam. The technology also may use the relationships between two users to infer new relationships between one of those users and a third user when a new connection between such users is made. In one aspect, the technology also allows classification of (non-spam) bulk senders so that end users can decide what type of bulk email they receive.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in spam detection and email message processing in general.

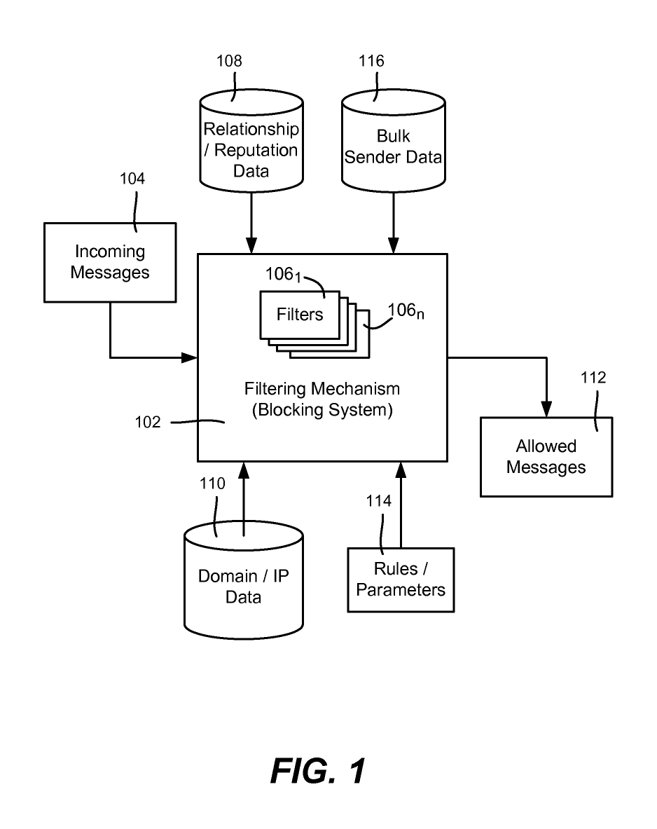

FIG. 1 shows example components of an email filtering system including a filtering mechanism 102 configured to scan incoming messages 104 with respect to spam detection. The filtering system may be deployed anywhere that email filtering is desired, such as on a hosted email filtering service, as part of a Microsoft® Exchange-based mail system, and so forth. An administrator or the like may configure the system as desired, e.g., set thresholds, rules and so forth that determine how messages are scanned and otherwise handled.

To filter messages, each incoming message 104 is processed using a number of filtering algorithms, referred to as filters 106₁-106ₙ. In general, the filters 106₁-106ₙ range in aggressiveness from very aggressive/expensive filters to less aggressive, inexpensive filters. For example, one filter may quickly scan for bad URLs, which is a very fast inexpensive filter, whereas an aggressive filter that scans the message body looking for certain words is a relatively slow, expensive filter. As will be understood, unlike existing filtering systems that apply all of the filters, (or none of them for senders designated by the user as “safe senders”), the number and type of filters that are applied are variable as described herein, based upon information known about the sender and the targeted recipient.

In one aspect, the filtering mechanism 102 selects the aggressiveness of filters (in part) by keeping track in an automated fashion who the end users exchange emails with, as represented in FIG. 1 via the relationship/reputation data store 108. For example, where there is a good relationship and reputation, the filtering mechanism 102 in general may only select those filters that look for malware/dangerous messages, which is far faster than running a complete filtering scan with all filters.

Another type of information used in determining how aggressive to filter a message 104 corresponds to whether the domain and IP address of the sender are able to be validated, that is, whether this IP address normally sends from the domain identified in the message. To this end, as represented in FIG. 1 by the domain/IP data store 110, the system 102 tracks the association of the e-mail domains with IP addresses used to send e-mails for these domains. After time, a consistent pattern of e-mails attributed to a particular domain and not detected as spam is a good indication that the IP addresses from which these e-mails are coming are likely to be legitimate mail relays for these domains, even if no SPF (Sender Policy Framework) or DKIM (DomainKeys Identified Mail) records are available, (which provide mechanisms to validate if an IP can send from a certain domain, but are not always present). Tracking and maintaining the domain/IP address associations in the data store 110 deduces similar information for domains that do not have SPF and/or DKIM information available, and further can be used as an addition to SPF and DKIM technology.

As described below, if the sending domain is not validated for sending from the IP (using SPF, DKIM and/or the accumulated IP/Domain data tracked in the data store 110), the filtering mechanism 102 will aggressively filter the message 104. Conversely, if validated, the filtering mechanism 102 checks the relationship/reputation data store 108 to determine whether the sender address and recipient address have a recorded relationship along with reputation information that is used determine a score or the like (e.g., a classification) representative of how likely the message 104 is to be spam. In general, the relationship/reputation data store 108 is built up over time based on messages that are communicated between users and the results of spam scanning with respect to those messages. It is also feasible to obtain some of the relationship data from other sources, to the extent that such information is available and can be trusted. For example, a user may specify that a relationship exists.

If there is a relationship and the accumulated reputation information indicates a low likelihood of the e-mail being a spam message, only inexpensive, lightweight (less aggressive) filters are applied. In the event that the computed score corresponds to unknown or bad reputation information, then set of more aggressive filters is selected and applied. Those messages that are detected as spam are filtered out in some way, e.g., blocked or sent to a junk folder, while those that pass spam filtering detection are delivered as allowed messages 112.

By way of an example, if sender A has sent some threshold number of messages to recipient B, such as five or more messages, and none have ever contained spam, then the likelihood of the next message being spam is low. As can be readily appreciated, the likelihood score or the like may be computed based upon the number of messages sent from that sender to the recipient and/or messages sent from that recipient to the sender; e.g., the more messages the better the score (the lower the likelihood of spam), with any detected spam worsening the score (increasing the likelihood of spam). Note that the relationship and the accumulated reputation information may be aged or weighted based on time, possibly with older data expired, so that eventually a stale relationship may be considered to no longer exist, an old (e.g., incorrectly detected/false positive) “spam” message will not always remain a factor, and so on.

As is known, typical e-mail exchanges tend to cluster around social or business relationships, e.g., a large percentage of email messages that a typical user receives involve the same senders. For such senders and corresponding repeated mail exchanges, the expense and aggressiveness of anti-spam scanning may be lessened where there is little or no risk of spam, without reducing the overall effectiveness of anti-spam detection.

Turning to another aspect, in addition to direct relationships between senders and recipients, indirect relationships may also be used to reduce the aggressiveness of spam filtering. For example, when the filtering mechanism 102 encounters an unknown relationship, the mechanism can scan the data store 108 to see if the sender has a relationship already built with others in the system, and use that information to infer a good relationship. For example if A and B have a good relationship, B and C have a good relationship, but a qualified relationship between A and C does not exist (including when there is some previous communications, but not enough to meet a threshold), the filtering mechanism 102 is able to infer an indirect relationship and thereby filter the mail less aggressively to some extent, (possibly not to the same extent as if there was a direct relationship). For example, instead of an initial score (e.g., zero) indicating no qualified relationship exists, the initial score may be set to some (e.g. non-zero) starting value if there is an indirect relationship.

Note that the above example only describes a relationship through a single intermediary used to determine the indirect relationship, although it is feasible to have more than one intermediary. For example, (A,B), (B,C), (C,D) may represent direct relationships, whereby not only may a single intermediary indirect relationship of (A-C) be inferred, but also a double intermediary indirect relationship (A-D), and so on.

It is possible that a formerly good sender will start sending bad email, such as if that sender's computer becomes infected with malware. To detect such a situation, a small percentage (sampling) of emails may be more aggressively filtered regardless of the reputation/relationship status. To this end, various rules and parameters 114 may be set (e.g., by an administrator) to override the reputation/relationship processing. In the event that a formerly good user starts sending spam in any quantity, any existing relationships will be quickly invalidated. Another situation that can result in a relationship being invalidated is when an end user or administrator reports back to the system that an email message they received was spam/unwanted.

It should be noted that some mail clients/systems provide a “Safe Sender” mechanism for marking email senders as “Safe Senders.” Typically e-mail from Safe Senders is not scanned for spam at all. In contrast, the technology described herein is more efficient and flexible, because rather than excluding e-mails from anti-spam scanning altogether, some scanning may be performed (e.g., at least for malware), with the depth of anti-spam scanning depending on the likelihood of the e-mail message being a spam. Note further that the technology described herein may use broad social networking-style information derived from multiple users, whereas traditional Safe Sender systems are limited to the single user e-mail exchange history and contacts.

Turning to another aspect, the proposed system can also identify when an email address/IP is used for sending legitimate bulk email such as newsletters or sales offers that are legitimate and desired by many users. This may be accomplished by analyzing the volume and type of email the sender is sending out; for example, auto-confirm@bigretalier.com sender may send a very large volume of e-mails across a broad population of users, which can be quickly identified as a legitimate “bulk sender” rather than a spammer, with data for that bulk sender maintained in a suitable data store 116.

Once a bulk sender is identified, a subcategory of what type of mail they send may be set manually by an analyst or an end user to mark the mail as “Mailing list” or “Flyer,” for example, or whatever appropriate categories are desired. In this way, a retailer is categorized differently from a newsletter sender, for example.

Once the bulk mailers are categorized, an end user may specify what types of bulk email they wish to receive and what kinds they do not. For example a home user may wish to receive “Music Industry” email, while a business user does not. Such information may be maintained in the rules/parameters 114 and accessed to determine how to handle a bulk message, including on a per email system (e.g., the administrator blocks all bulk messages from company X, or of category Y) or on per-user basis.

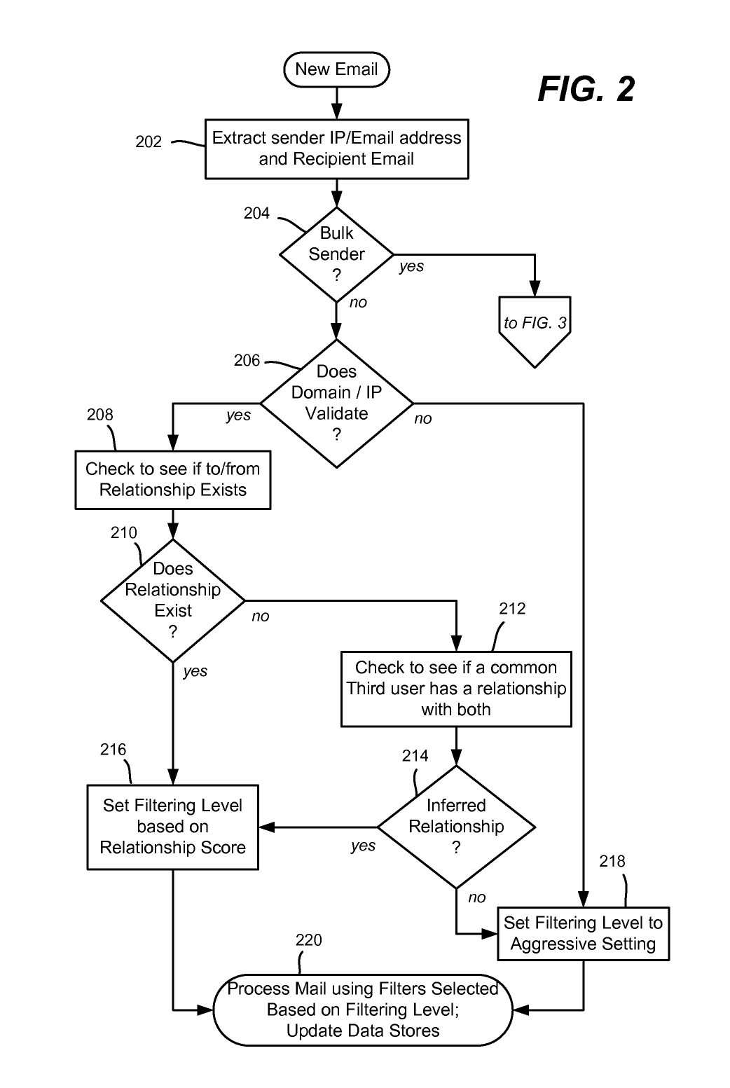

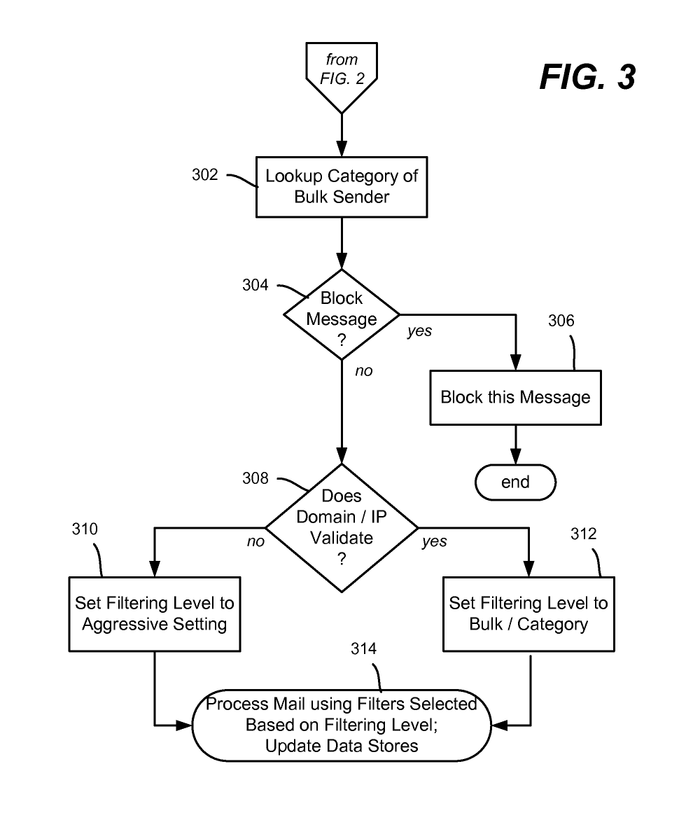

FIG. 2 is a flow diagram summarizing some of the various steps that a filtering system including the filtering mechanism 102 of FIG. 1 may perform in scanning for spam messages. At step 202, the filtering mechanism processes the message to extract the sender IP/email address and recipient email. Step 204 determines whether the message is from a bulk sender, and if so, the message may be processed with the example steps of FIG. 3 as described below.

Step 206 represents validating the domain with the IP address. As described above, this may be based upon information accumulated in the domain/IP data store 110, and/or via SPF/DKIM. If not validated, then the filtering level is set to the most aggressive level at step 218, where the corresponding filters for this level (e.g., all available) will be applied at step 220.

If the domain and IP address validate, steps 208 and 210 check whether any qualified, direct relationship exists. If so, the filtering level is set based upon the direct relationship and the reputation score at step 216. The corresponding filters for this filtering level (e.g., if a good reputation, only those that scan for malware) will be applied at step 220. Note that if the reputation is bad, the filtering level is increased accordingly, and may, for example, correspond to the most aggressive level.

If no direct relationship exists as evaluated at step 210, step 212 looks for whether a common relationship exists through a third party (only one intermediary is checked in this example implementation). If so as evaluated at step 214, the filtering level may be set based upon the indirect relationship (and possibly a reputation score based on the third party reputation) at step 216, and applied at step 220.

As described above, step 220 applies the filters that correspond to the filtering level determined via the previous steps. Step 220 also represents updating the data stores based on the IP address and domain, the to/from data, and/or the scanning results.

FIG. 3 represents example steps that may be taken when a message is determined to be from a bulk sender. Step 302 looks up the category of the bulk sender, e.g., a retailer, as described above. Step 304 represents evaluating whether this bulk sender and/or the corresponding category is to be blocked, e.g., as set by the targeted recipient and/or an administrator. If so, the message is blocked (or otherwise handled, e.g., put in a junk folder) as represented by step 306.

If not blocked, step 308 checks whether the domain and IP address validate. If not, then there is a possibility that the sender is not actually the bulk sender, but a spammer, whereby the filtering is set to the most aggressive level at step 310, and applied at step 314. Otherwise the filtering is set to a bulk sender level (which may vary by category) at step 312, generally to some less aggressive level since known good bulk senders do not send spam unless hacked. Step 314 also represents updating the databases as appropriate for the bulk message, e.g., a bulk sender may be sending from a new IP address, in which event the domain and new IP address will eventually validate at step 308.

As can be seen, by analyzing the history of message exchanges to determine associations of e-mail domains and authorized IP addresses used to send e-mails for these domains, and using this in combination with relationship/reputation data of the to and from email addresses, a filtering system may determine how aggressively an email message is scanned for spam. The social network of users may be further analyzed to determine if an indirect relationship exists between two users, with that information used to set an initial relationship value, for example, by which some less aggressive filtering may be chosen. Further, the system may implement the automatic identification of good bulk mail senders, so that the bulk sender can be manually classified by administrators and/or end users, with its messages correspondingly handled and/or scanned.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

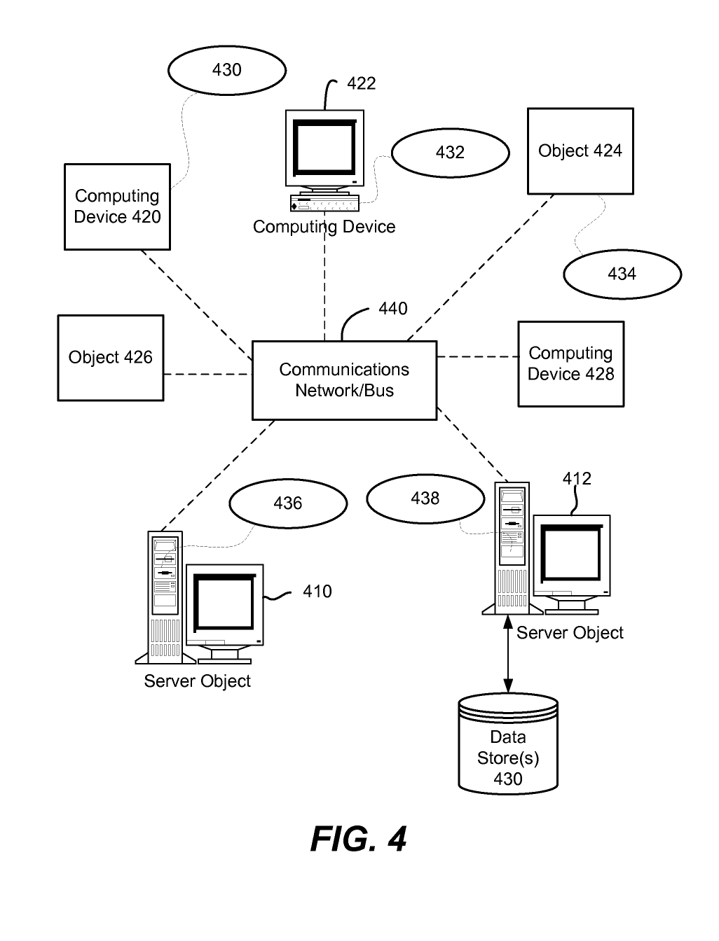

FIG. 4 provides a schematic diagram of an exemplary networked or distributed computing environment. The distributed computing environment comprises computing objects 410, 412, etc., and computing objects or devices 420, 422, 424, 426, 428, etc., which may include programs, methods, data stores, programmable logic, etc. as represented by example applications 430, 432, 434, 436, 438. It can be appreciated that computing objects 410, 412, etc. and computing objects or devices 420, 422, 424, 426, 428, etc. may comprise different devices, such as personal digital assistants (PDAs), audio/video devices, mobile phones, MP3 players, personal computers, laptops, etc.

Each computing object 410, 412, etc. and computing objects or devices 420, 422, 424, 426, 428, etc. can communicate with one or more other computing objects 410, 412, etc. and computing objects or devices 420, 422, 424, 426, 428, etc. by way of the communications network 440, either directly or indirectly. Even though illustrated as a single element in FIG. 4, communications network 440 may comprise other computing objects and computing devices that provide services to the system of FIG. 4, and/or may represent multiple interconnected networks, which are not shown. Each computing object 410, 412, etc. or computing object or device 420, 422, 424, 426, 428, etc. can also contain an application, such as applications 430, 432, 434, 436, 438, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 4, as a non-limiting example, computing objects or devices 420, 422, 424, 426, 428, etc. can be thought of as clients and computing objects 410, 412, etc. can be thought of as servers where computing objects 410, 412, etc., acting as servers provide data services, such as receiving data from client computing objects or devices 420, 422, 424, 426, 428, etc., storing of data, processing of data, transmitting data to client computing objects or devices 420, 422, 424, 426, 428, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 440 or bus is the Internet, for example, the computing objects 410, 412, etc. can be Web servers with which other computing objects or devices 420, 422, 424, 426, 428, etc. communicate via any of a number of known protocols, such as the hypertext transfer protocol (HTTP). Computing objects 410, 412, etc. acting as servers may also serve as clients, e.g., computing objects or devices 420, 422, 424, 426, 428, etc., as may be characteristic of a distributed computing environment.

### Exemplary Computing Device

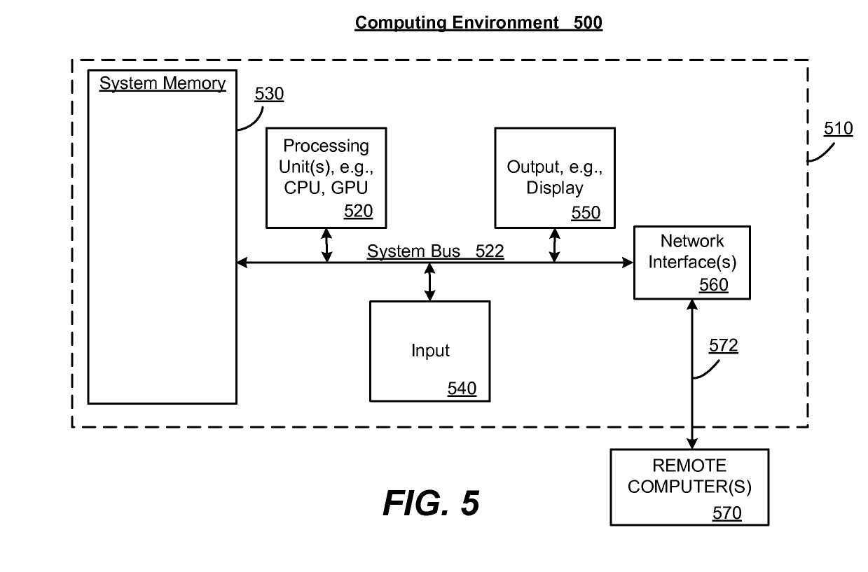

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 5 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 5 thus illustrates an example of a suitable computing system environment 500 in which one or aspects of the embodiments described herein can be implemented, although as made clear above, the computing system environment 500 is only one example of a suitable computing environment and is not intended to suggest any limitation as to scope of use or functionality. In addition, the computing system environment 500 is not intended to be interpreted as having any dependency relating to any one or combination of components illustrated in the exemplary computing system environment 500.

With reference to FIG. 5, an exemplary remote device for implementing one or more embodiments includes a general purpose computing device in the form of a computer 510. Components of computer 510 may include, but are not limited to, a processing unit 520, a system memory 530, and a system bus 522 that couples various system components including the system memory to the processing unit 520.

Computer 510 typically includes a variety of computer readable media and can be any available media that can be accessed by computer 510. The system memory 530 may include computer storage media in the form of volatile and/or nonvolatile memory such as read only memory (ROM) and/or random access memory (RAM). By way of example, and not limitation, system memory 530 may also include an operating system, application programs, other program modules, and program data.

A user can enter commands and information into the computer 510 through input devices 540. A monitor or other type of display device is also connected to the system bus 522 via an interface, such as output interface 550. In addition to a monitor, computers can also include other peripheral output devices such as speakers and a printer, which may be connected through output interface 550.

The computer 510 may operate in a networked or distributed environment using logical connections to one or more other remote computers, such as remote computer 570. The remote computer 570 may be a personal computer, a server, a router, a network PC, a peer device or other common network node, or any other remote media consumption or transmission device, and may include any or all of the elements described above relative to the computer 510. The logical connections depicted in FIG. 5 include a network 572, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
receiving an email message directed from a sender to a recipient;
obtaining information indicative of whether an IP address and domain of the sender validate, and,
if the IP address and domain of the sender do not validate, determining a filtering level based upon the information; and
if the IP address and domain of the sender validate, determining whether the sender and recipient have a relationship with respect to previously communicated email messages, and if so, determining a filtering level based upon the relationship and reputation information associated with the relationship; and
selecting a selected filter set comprising one or more spam filters based on the filtering level.

2. The method of claim 1 further comprising, scanning the email message with the selected filter set and handling the email message based upon a result of the scanning.

3. The method of claim 1 wherein obtaining the information indicative of whether the IP address and the domain of the sender validate comprises accessing a data store that tracks IP addresses and domains of senders with respect to previous email message communications.

4. The method of claim 1 wherein obtaining the information indicative of whether the IP address and the domain of the sender validate comprises accessing SPF or DKIM data, or both SPF and DKIM data.

5. The method of claim 1 wherein when the IP address and domain of the sender do not validate, determining the filtering level comprises selecting a most aggressive filtering level.

6. The method of claim 1 wherein determining the filtering level based upon the relationship and reputation information associated with the relationship comprises computing a score based upon a number of prior communications between the sender and recipient.

7. The method of claim 1 wherein determining the filtering level based upon the relationship and reputation information comprises computing a score based upon results of one or more previous spam scans.

8. The method of claim 1 wherein determining the sender and recipient do not have a relationship with respect to previously communicating email messages, and further comprising, if so, determining whether the sender and recipient have an indirect relationship, and if so, determining a filtering level based upon the indirect relationship.

9. The method of claim 1 wherein determining whether the sender and recipient have an indirect relationship comprises determining whether the sender and recipient each have a relationship a common third party with respect to previously communicated email messages.

10. The method of claim 1 wherein the sender is a bulk sender, and further comprising, determining whether to block the email message based upon a category associated with the bulk sender and at least one rule associated with that bulk sender.

11. The method of claim 1 wherein the sender is a bulk sender, and further comprising, determining a filtering level based upon the sender being a bulk sender, or a category associated with the bulk sender, or based upon both the sender being a bulk sender and a category associated with the bulk sender.

12. In a computing environment, a system, comprising:
a relationship and reputation data store that maintains information corresponding to email communications between senders and recipients, and reputation of the email communications with respect to spam;
a filtering mechanism coupled to the relationship and reputation data store, the filtering mechanism configured to scan incoming email messages for spam via a plurality of different filters, and for each message to be scanned, the filtering mechanism configured to scan that message with selected filters based upon whether that message's domain and IP address validate, or based upon information in the relationship and reputation data store regarding a sender and recipient of that message.

13. The system of claim 12 wherein the filtering mechanism is configured to differentiate messages received from a bulk sender from other messages, to categorize the messages received from the bulk sender, and to block or scan messages based upon the categorization with respect to a set of one or more rules.

14. The system of claim 12 further comprising a domain and IP address data store that maintains information corresponding to previous email communications from senders, the filtering mechanism configured to access the and IP address data store for a message to determine whether that message's domain and IP address validate.

15. The system of claim 12 wherein the information in the relationship and reputation data store indicates a direct relationship between the sender and the recipient with respect to one or more previous email communications.

16. The system of claim 12 wherein the information in the relationship and reputation data store indicates an indirect relationship between the sender and the recipient with respect to one or more previous email communications between the sender and a third party and the recipient and the third party.

17. One or more computer-readable media having computer-executable instructions, which when executed perform steps, comprising:
(a) receiving an email message directed from a sender to a recipient;
(b) determining whether an IP address and domain of the sender validate, and, if not, advancing to step (d);
(c) determining whether the sender and recipient have a relationship with respect to previously communicated email messages, and if so, setting a selected filtering level to a first filtering level based upon the relationship and reputation information associated with the relationship, and advancing to step (e);
(d) setting a selected filtering level to a second filtering level that is more aggressive than the first filtering level;
(e) selecting a selected filter set comprising one or more spam filters based on the selected filtering level; and
(f) scanning the email message with the selected filter set.

18. The one or more computer-readable media of claim 17 wherein determining at step (c) whether the sender and recipient have a relationship comprises determining whether a direct qualified relationship exists, and if not, determining whether an indirect qualified relationship exists.

19. The one or more computer-readable media of claim 18 wherein when a direct qualified relationship exists, setting the selected filtering level to the first filtering level comprises choosing a low aggressiveness filtering level, and when a direct qualified relationship does not exist and an indirect qualified relationship exists, setting the selected filtering level to the first filtering level comprises choosing a medium aggressiveness filtering level that is between the low aggressiveness level and the second filtering level.

20. The one or more computer-readable media of claim 18 wherein determining whether a qualified indirect relationship exists comprises determining whether the sender and recipient each have a qualified relationship with a common third party.
